(19) United States
(12) Patent Application Publication
(10) Pub. No.: US 2007/0008323 A1
(43) Pub. Date: Jan. 11, 2007

(54) Reference picture loading cache for motion prediction

(76) Inventor: Yaxiong Zhou, San Jose, CA (US)

Correspondence Address: MAYER, BROWN, ROWE & MAW LLP, P.O. BOX 2828, CHICAGO, IL, 60690-2828, US

(21) Appl. No.: 11/178,003

(22) Filed: Jul. 8, 2005

(51) Int. Cl. G06T 15/70

(52) U.S. Cl. 345/475

(57) ABSTRACT

Video coders use motion prediction, where a reference frame is used to predict a current frame. Most video compression standards require reference frame buffering and accessing. Given the randomized memory accesses to store and access reference frames, there are substantial overlapped areas. Conventional techniques fail to recognize this overlap, and perform duplicate loading, thereby causing increased memory traffic. Techniques disclosed herein reduce the memory traffic by avoiding the duplicated loading of overlapped area, by using a reference cache that is interrogated for necessary reference data prior to accessing reference memory. If the reference data is not in the cache, then that data is loaded from the memory and saved into the cache. If the reference data is in the cache, then that data is used instead of loading it from memory again. Thus, memory traffic is reduced by avoiding duplicated memory access to overlapped areas.

### RELATED APPLICATIONS

This application claims the benefit of U.S. Provisional Application No. 60/635,114, filed on Dec. 10, 2004, which is herein incorporated in its entirety by reference.

### FIELD OF THE INVENTION

The invention relates to video decoding, and more particularly, to the memory access of reference picture in motion prediction based video compression standards.

### BACKGROUND OF THE INVENTION

There are a number of video compression standards available, including MPEG1/2/4, H.263, H.264, Microsoft WMV9, and Sony Digital Video, to name a few. Generally, such standards employ a number of common steps in the processing of video images.

First, video images are converted from RGB format to the YUV format. The resulting chrominance components can then be filtered and sub-sampled of to yield smaller color images. Next, the video images are partitioned into 8x8 blocks of pixels, and those 8x8 blocks are grouped in 16x16 macro blocks of pixels. Two common compression algorithms are then applied. One algorithm is for carrying out a reduction of temporal redundancy, the other algorithm is for carrying out a reduction of spatial redundancy.

Spatial redundancy is reduced applying a discrete cosine transform (DCT) to the 8×8 blocks and then entropy coding by Huffman tables the quantized transform coefficients. In particular, spatial redundancy is reduced applying eight times horizontally and eight times vertically an 8×1 DCT transform. The resulting transform coefficients are then quantized, thereby reducing to zero small high frequency coefficients. The coefficients are scanned in zigzag order, starting from the DC coefficient at the upper left corner of the block, and coded with variable length coding (VLC) using Huffman tables. The DCT process significantly reduces the data to be transmitted, especially if the block data is not truly random (which is usually the case for natural video). The transmitted video data consists of the resulting transform coefficients, not the pixel values. The quantization process effectively throws out low-order bits of the transform coefficients. It is generally a lossy process, as it degrades the video image somewhat. However, the degradation is usually not noticeable to the human eye, and the degree of quantization is selectable. As such, image quality can be sacrificed when image motion causes the process to lag. The VLC process assigns very short codes to common values, but very long codes to uncommon values. The DCT and quantization processes result in a large number of the transform coefficients being zero or relatively simple, thereby allowing the VLC process to compress these transmitted values to very little data. Note that the transmitter encoding functionality is reversible at the decoding process performed by the receiver. In particular, the receiver performs dequantization (DEQ), inverse DCT (IDCT), and variable length decoding (VLD) on the coefficients to obtain the original pixel values.

Temporal redundancy is reduced by motion compensation applied to the macro blocks according to the picture structure. Encoded pictures are classified into three types: I, P, and B. I-type pictures represent intra coded pictures, and are used as a prediction starting point (e.g., after error recovery or a channel change). Here, all macro blocks are coded without prediction. P-type pictures represent predicted pictures. Here, macro blocks can be coded with forward prediction with reference to previous I-type and P-type pictures, or they can be intra coded (no prediction). B-type pictures represent bi-directionally predicted pictures. Here, macro blocks can be coded with forward prediction (with reference to previous I-type and P-type pictures), or with backward prediction (with reference to next I-type and P-type pictures), or with interpolated prediction (with reference to previous and next I-type and P-type pictures), or intra coded (no prediction). Note that in P-type and B-type pictures, macro blocks may be skipped and not sent at all. In such cases, the decoder uses the anchor reference pictures for prediction with no error.

Most of the video compression standards require reference frame buffering and accessing during motion prediction processing. Due to the randomness of the motion split modes and motion vectors, the reference picture memory accesses are also random in position and shape. Between all the randomized memory accesses, there are many overlapped areas, which are areas of the memory that are accessed more than once in a given decoding session. Thus, there is a significant amount of memory traffic due to duplicated memory access.

What is needed, therefore, are techniques reducing the memory traffic associated with reference frame buffering and accessing during motion prediction processing.

### SUMMARY OF THE INVENTION

One embodiment of the present invention provides a reference picture cache system for motion prediction in a video processing operation. The system includes a video decoder for carrying out motion prediction of a video data decoding process, a caching module for caching reference data used by the video decoder for motion prediction, and a DMA controller that is responsive to commands from the caching module, for accessing a memory that includes reference data not available in the caching module. In one such embodiment, requests for reference data from the video decoder identify requested reference data (e.g., cache address information of requested reference data), so that availability of requested data in the caching module can be determined. In one particular case, one or more cache line requests are derived from each request for reference data from the video decoder, where each cache line request identifies cache address information of requested reference data, and a tag that indicates availability of requested data in the caching module. In one such case, and in response to the tag of a cache line request matching a tag in the caching module, the caching module returns cached reference data corresponding to that tag.

Another embodiment of the present invention provides a reference picture cache system for motion prediction in a video processing operation. In this particular configuration, the system includes a reference data cache (e.g., for reducing memory access traffic), and a tag controller for receiving a request from a video decoder for reference data used in motion prediction, splitting that request into a number of cache line memory access requests, and generating a cache command for each of those cache line memory access requests to indicate availability of corresponding reference data in lines of the reference data cache. The system further includes a data controller that is responsive to cache commands from the tag controller, for reading available reference data from the reference cache and returning that data to a video decoder, thereby reducing data traffic associated with memory access. The system may also include a command buffer for storing the cache commands generated by the tag controller. Here, the data controller can read each cache command from the command buffer. In one particular case, the request from the video decoder for reference data indicates a position and shape of a requested reference region. The position can be defined, for example, in X and Y coordinates with unit of pixel, and the shape can be defined in width and height with unit of pixel. Each of the cache line memory access requests can have its own X and Y coordinates derived from the request from the video decoder. In one such case, some bits of the X and Y coordinates are concatenated together and used as a cache line address, and other bits of the X and Y coordinates are used as a cache tag, which indicates availability of requested reference data for the corresponding cache line request. In response to a cache command indicating the corresponding reference data is not available in the reference data cache, the data controller can read that reference data from a DMA controller and can then return that data to the video decoder. In one such case, the tag controller continues processing subsequent cache lines without waiting for the reference data to be returned by the DMA controller, and the command buffer is sized to tolerate latency of the DMA controller. The reference data cache may include, for instance, a data memory for storing reference data of each cache line, and a tag memory for storing tags that indicate status of each cache line. The status of each cache line may include, for example, at least one of availability and position of each cache line. The reference data cache can be implemented, for example, with one or more pieces of on-chip SRAM. The system can be implemented, for example, as a system-on-chip.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram of a reference picture loading cache architecture for motion prediction, configured in accordance with one embodiment of the present invention.

FIG. 2a illustrates an example of a requested reference region that has been divided into N smaller cache line memory access requests, in accordance with one embodiment of the present invention.

FIG. 2b illustrates an example of a requested cache line shown in FIG. 2a, in accordance with one embodiment of the present invention.

FIG. 2c illustrates an example of how the position of the requested cache line shown in FIG. 2b can be used to specify the reference cache address and tag, in accordance with one embodiment of the present invention.

### DETAILED DESCRIPTION OF THE INVENTION

Techniques for reducing memory traffic associated with reference frame buffering and accessing during motion prediction processing are disclosed. The techniques can be used in decoding any one of a number of video compression formats, such as MPEG1/2/4, H.263, H.264, Microsoft WMV9, and Sony Digital Video. The techniques can be implemented, for example, as a system-on-chip (SOC) for a video/audio decoder for use in high definition television broadcasting (HDTV) applications, or other such applications. Note that such a decoder system/chip can be further configured to perform other video functions and decoding processes as well, such as DEQ, IDCT, and/or VLD.

General Overview

Video coders use motion prediction, where a reference frame is used to predict a current frame. As previously explained, most video compression standards require reference frame buffering and accessing. Given the randomized memory accesses to store and access reference frames, there are a lot of overlapped areas. Conventional techniques fail to recognize this overlap, and perform duplicate loading, thereby causing increased memory traffic. Embodiments of the present invention reduce the memory traffic by avoiding the duplicated loading of overlapped area.

In one particular embodiment, a piece of on-chip SRAM (or other suitable memory) is used as a cache of the reference frame. All the reference picture memory accesses are split into small pieces with unified shapes. For each small piece, a first check is made to see if that piece is already in the cache. If it is not, then the data is loaded from the memory and it is saved into the cache. On the other hand, if that piece is already in the cache, then the data in the cache is used instead of loading it from memory again. Thus, memory traffic is reduced by avoiding duplicated memory access to overlapped areas.

In operation, for each macro block, preliminary memory access requests are generated based on the motion split modes and motion vectors. Each preliminary memory access request includes two pieces of information: the position and the shape of the reference region. In one particular such embodiment, the position is defined in X and Y coordinates with unit of pixel, and the shape is defined in width and height with unit of pixel. Each of these preliminary memory access requests are split into a number of small (e.g., 8 pixel by 2 pixel) cache line memory access requests with their own X and Y coordinates (which are derived from the X and Y coordinates of the overall reference region). The lower several bits of the cache line X and Y coordinates (configurable based on the available cache size) are concatenated together and used as the cache address. The remaining part of those coordinates is used as the cache tag, which indicates what part of the reference picture is cached.

With the cache address of the memory access request, cache info can be loaded from the cache SRAM to determine if the requested data is cached. The cache SRAM stores two things: cache data and cache tags. If the tag in the cache info is the same as the tag of the cache line request, then the data in the cache info will be returned and no memory traffic is generated. If the tag in the cache info is different from the tag of the cache line request, then the request is passed to the memory, and the data from the memory is returned and saved into the cache SRAM together with the tag of the cache line request.

Architecture

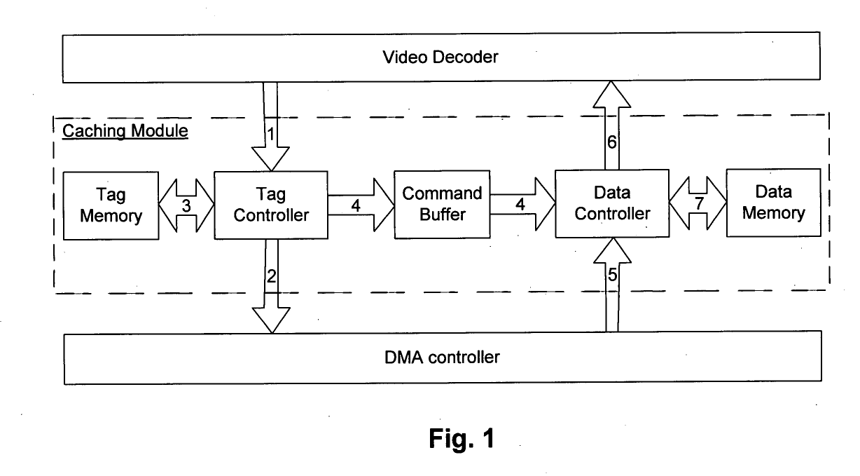

FIG. 1 is a block diagram of a reference picture loading cache system for motion prediction, configured in accordance with one embodiment of the present invention.

The system can be implemented, for example, as an application specific integrated circuit (ASIC) or other purpose-built semiconductor. A caching approach is used to reduce memory traffic associated with reference frame buffering and accessing during motion prediction processing. Such a configuration enables high definition decoding and a constant throughput.

As can be seen, the system includes a caching module that is communicatively coupled between a video decoder and a direct memory access (DMA) controller. The DMA controller and the video decoder can each be implemented with conventional or custom technology, as will be apparent in light of this disclosure. In operation, when a reference frame is required by the video decoder to carry out motion prediction, a memory access request is provided to the caching module. The caching module determines if it has the reference data associated with the request, and if so, provides that data to the video decoder. Otherwise, the caching module requests posts the request to the DMA controller. The caching module then caches the reference data received from the DMA controller, and provides that data to the video decoder. In either case, the video decoder has the data it needs to carry out the decoding process, including motion prediction.

In this embodiment, the caching module includes a-tag memory, a tag controller, a command buffer, a data controller, and a data memory. A number of variations on this configuration can be implemented here. For example, although the tag memory, command buffer, and data memory are shown as separate modules, they can be implemented using a single memory. Similarly, the functionality of the tag controller and the data controller can be implemented using a single controller or other suitable processing environment.

For each macro block, preliminary memory access requests are generated by the video decoder, based on the motion split modes and motion vectors. Each preliminary memory access request includes two pieces of information: the position and the shape of the reference region. In one particular such embodiment, the position is defined in X and Y coordinates with unit of pixel, and the shape is defined in width and height with unit of pixel.

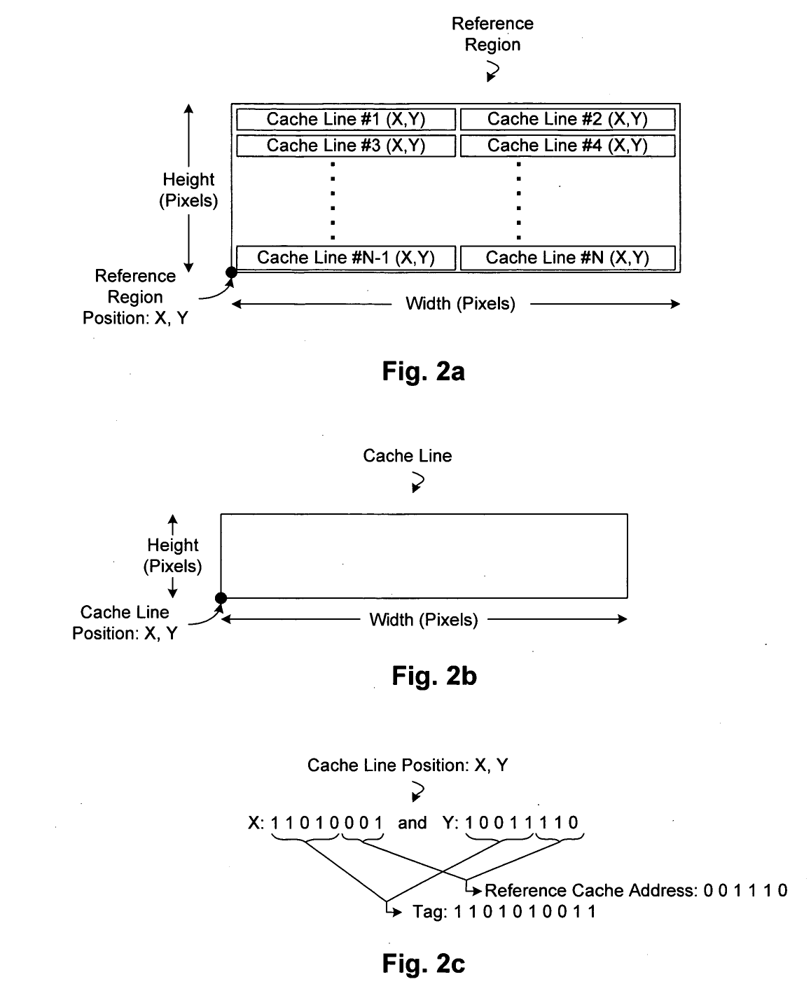

The tag controller receives the preliminary memory access requests for reference data (e.g., a region of a reference frame) from the video decoder, and splits them into a number of small (e.g., 8 pixel by 2 pixel) cache line memory access requests with their own X and Y coordinates. FIG. 2a illustrates an example of a requested reference region that has been divided into N smaller cache line memory access requests, in accordance with one embodiment of the present invention. FIG. 2b illustrates an example of a requested cache line shown in FIG. 2a, in accordance with one embodiment of the present invention.

FIG. 2c illustrates an example of how the position of the requested cache line shown in FIG. 2b can be used to specify the reference cache address and tag of that cache line, in accordance with one embodiment of the present invention. In particular, the lower several bits of the cache line X and Y coordinates (configurable based on the available cache size) are concatenated together and used as the cache address. The remaining part of the coordinates is used as the cache tag, which indicates what part of the reference picture is cached.

With the cache address of the memory access request, cache info can be loaded from the reference cache (e.g., in the tag memory portion) to determine if the requested data is cached (e.g., in the data memory portion). In more detail, and with reference to the particular embodiment shown in FIG. 1, the reference cache includes the data memory and the tag memory. The data memory is for storing reference data (for use in motion prediction) of each cache line, and the tag memory is for storing tags that indicate the status of each cache line (e.g., availability and position). Each of the tag memory and data memory can be implemented, for example, with a piece of on-chip SRAM, or other suitable fast access memory.

Based on the position of each cache line request, the tag controller reads the corresponding cache tag from the tag memory, checks the status of the cache line, sends a cache command into the command buffer to inform the data controller of the cache line status, and updates the cache line status in the tag memory. If the cache misses, the tag controller will send a memory request to the DMA controller to load the missed cache line.

The command buffer stores the cache command generated by the tag controller. In this embodiment, a cache command includes the information of cache line status. In case of a cache miss, note that it may take DMA controller some time to return the requested data. Thus, in one embodiment, the tag controller will keep on processing the next cache line without waiting for the data to come back from the DMA controller. In such a configuration, the command buffer should be sufficiently large enough to tolerate the latency of the DMA controller.

The data controller reads the cache command from command buffer. If the cache command indicates a cache hit, the data controller reads the data from the data memory and returns that data to the video decoder. In the case of a cache miss, the data controller reads the data from the DMA controller, returns it to the video decoder, and updates the cache line in the data memory to include that data.

Data Structure and Formats

Memory Access Request from Video Decoder: This is the data that is sent via path 1 of FIG. 1. In one particular embodiment, a memory access request from the video decoder is a 32-bit data structure used to indicate the position and shape of the data to be loaded from memory. One such example format is as follows:

| 31:20 | 19:8 | 7:4 | 3:0 |
|---|---|---|---|
| Position-X | Position-Y | Size-X | Size-Y |

Here, the position is defined in X and Y coordinates with unit of pixel, where the X coordinate is indicated by bits 20-31, and the Y coordinate is indicated by bits 8-19. In addition, the shape is defined in width and height with unit of pixel, where the width (X) is indicated by bits 4-7, and the height (Y) is indicated by bits 0-3. Other formats will be apparent in light of this disclosure, as goes for the other data structures/formats discussed herein.

Cache Line Memory Load Request to DMA Controller: This is the data that is sent via path 2 of FIG. 1. In one embodiment, this request can have the same structure as the “memory access request from the video decoder” previously discussed, but only the request for the missed cache line is posted to DMA controller.

Tag Status: This is the data that is sent via path 3 of FIG. 1. In one embodiment, the tag status is a 17-bit data structure used to indicate the availability and position of the cache line in the memory. One such example format is as follows:

| 16 | 15:8 | 7:0 |
|---|---|---|
| Cached | Cache-TagX | Cache-TagY |

As can be seen in this example, bit 16 is used to indicate if the cache line is cached or not (in the reference cache). Cache-TagX is an 8-bit number (bits 8-15) that indicates the X position of the cache line in the memory. This byte can be, for example, the same as bits 31:24 in the data structure for the “memory access request from the video decoder” previously discussed. Cache-TagY is an 8-bit number (bits 0-7) that indicate the Y, position of the cache line in the memory. This byte can be, for example, the same as bits 19:12 in the data structure for the “memory access request from the video decoder” previously discussed.

Cache Command: This is the data that is sent via path 4 of FIG. 1. In one embodiment, the cache command is a 9-bit data structure used to indicate the availability and address of the cache line in the reference cache. One such example format is as follows:

| 8 | 7:4 | 3:0 |
|---|---|---|
| Cached | Cache-AdrX | Cache-AdrY |

As can be seen in this example, bit 8 is used to indicate if the cache line is cached or not. Cache-AdrX is a 4-bit number (bits 4-7) that indicates the X address of the cache line in the reference cache. This nibble can be, for example, the same as bits 23:20 in the data structure for the “memory access request from the video decoder” previously discussed. Cache-AdrY is a 4-bit number (bits 0-3) that indicates the Y address of the cache line in the reference cache. This nibble can be, for example, the same as bits 11:8 in the data structure for the “memory access request from the video decoder” previously discussed.

Data from DMA Controller: This is the data that is sent via path 5 of FIG. 1. In one embodiment, data from the DMA controller is a 128-bit data structure of video pixel data. One such example format is as follows:

| 127:120 | 119:112 | . . . | 15:8 | 7:0 |
|---|---|---|---|---|
| Pixel 15 | Pixel 14 | . . . | Pixel 1 | Pixel 0 |

As can be seen, each structure represents 16 pixels (e.g., one 4×4 sub block, or one row of a 16×16 macro block), with each pixel represented by 8 pixels.

Data Returned to Video Decoder: This is the data returned to the video decoder on path 6 of FIG. 1, and can have the same structure as the “data from the DMA controller” as previously discussed.

Cache Line Data. This is the data returned to the video decoder on path 7 of FIG. 1, and can have the same structure as the “data from the DMA controller” as previously discussed.

The foregoing description of the embodiments of the invention has been presented for the purposes of illustration and description. It is not intended to be exhaustive or to limit the invention to the precise form disclosed. Many modifications and variations are possible in light of this disclosure. For instance, numerous bus and data structures can be implemented in accordance with the principles of the present invention. It is intended that the scope of the invention be limited not by this detailed description, but rather by the claims appended hereto.

What is claimed is:

1. A reference picture cache system for motion prediction in a video processing operation, comprising:
a reference data cache for reducing memory access traffic;
a tag controller for receiving a request from a video decoder for reference data used in motion prediction, splitting that request into a number of cache line memory access requests, and generating a cache command for each of those cache line memory access requests to indicate availability of corresponding reference data in lines of the reference data cache;
a command buffer for storing the cache commands generated by the tag controller; and
a data controller for reading each cache command from the command buffer, wherein in response to a cache command indicating the corresponding reference data is available in the reference data cache, the data controller reads that reference data from the reference cache and returns that data to the video decoder.

2. The system of claim 1 wherein the request from the video decoder for reference data indicates a position and shape of a requested reference region.

3. The system of claim 2 wherein the position is defined in X and Y coordinates with unit of pixel, and the shape is defined in width and height with unit of pixel.

4. The system of claim 1 wherein each of the cache line memory access requests has its own X and Y coordinates derived from the request from the video decoder.

5. The system of claim 4 wherein some bits of the X and Y coordinates are concatenated together and used as a cache line address, and other bits of the X and Y coordinates are used as a cache tag, which indicates availability of requested reference data for the corresponding cache line request.

6. The system of claim 1 wherein in response to a cache command indicating the corresponding reference data is not available in the reference data cache, the data controller reads that reference data from a DMA controller and returns that data to the video decoder.

7. The system of claim 6 wherein the tag controller continues processing subsequent cache lines without waiting for the reference data to be returned by the DMA controller, and the command buffer is sized to tolerate latency of the DMA controller.

8. The system of claim 1 wherein the reference data cache includes a data memory for storing reference data of each cache line, and a tag memory for storing tags that indicate status of each cache line.

9. The system of claim 8 wherein the status of each cache line includes at least one of availability and position of each cache line.

10. The system of claim 1 wherein the reference data cache is implemented with one or more pieces of on-chip SRAM.

11. The system of claim 1 wherein the system is implemented as a system-on-chip.

12. A reference picture cache system for motion prediction in a video processing operation, comprising:
a reference data cache;
a tag controller for receiving a request from a video decoder for reference data used in motion prediction, splitting that request into a number of cache line memory access requests, and generating a cache command for each of those cache line memory access requests to indicate availability of corresponding reference data in lines of the reference data cache; and
a data controller that is responsive to cache commands from the tag controller, for reading available reference data from the reference cache and returning that data to a video decoder, thereby reducing data traffic associated with memory access.

13. The system of claim 12 wherein each of the cache line memory access requests has its own X and Y coordinates derived from the request from the video decoder.

14. The system of claim 12 wherein in response to a cache command indicating the corresponding reference data is not available in the reference data cache, the data controller reads that reference data from a DMA controller and returns that data to the video decoder.

15. The system of claim 14 wherein the tag controller continues processing subsequent cache lines without waiting for the reference data to be returned by the DMA controller, and the command buffer is sized to tolerate latency of the DMA controller.

16. A reference picture cache system for motion prediction in a video processing operation, comprising:
a video decoder for carrying out motion prediction of a video data decoding process;
a caching module for caching reference data used by the video decoder for motion prediction; and
a DMA controller that is responsive to commands from the caching module, for accessing a memory that includes reference data not available in the caching module.

17. The system of claim 16 wherein requests for reference data from the video decoder identify requested reference data, so that availability of requested data in the caching module can be determined.

18. The system of claim 16 wherein requests for reference data from the video decoder identify cache address information of requested reference data, so that availability of that requested data in the caching module can be determined.

19. The system of claim 16 wherein one or more cache line requests are derived from each request for reference data from the video decoder, each cache line request identifying cache address information of requested reference data, and a tag that indicates availability of requested data in the caching module.

20. The system of claim 19 wherein in response to the tag of a cache line request matching a tag in the caching module, the caching module returns cached reference data corresponding to that tag.
